(19) United States
(12) Patent Application Publication
(10) Pub. No.: US 2010/0165570 A1
(43) Pub. Date: Jul. 1, 2010

(54) LATCHING STRUCTURE AND PORTABLE ELECTRONIC DEVICE WITH THE SAME

(75) Inventor: LU ZUO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/542,039

(22) Filed: Aug. 17, 2009

(30) Foreign Application Priority Data
Dec. 31, 2008 (CN) 200810306732.8

(51) Int. Cl. G06F 1/16

(52) U.S. Cl. 361/679.58

(57) ABSTRACT

A latching structure for a portable electronic device, the portable electronic device has a touch pen and a housing defined a slot to received the touch pen, the latching structure comprises at least a mounting portion formed on the housing; a least a latching module fixed in the mounting portion; each latching module has a latching element and an elastic element; the latching element is rotationally fixed in the mounting portion and elastically resists against the touch pen by the elastic force of the elastic element. A portable electronic device having the latching structure is also disclosed.

### BACKGROUND

1. Technical Field

The present disclosure generally relates to latching structures, and particularly to a latching structure for portable electronic device with touch pen and portable electronic device with the same.

2. Description of Related Art

Most portable electronic devices include touch operations. Taking a personal digital assistant (PDA) as an example, there is usually a touch pen for the PDA. The touch pen is inserted into the portable electronic device and held in the PDA by friction. However, the engagement surfaces of the PDA and the touch pen are apt to get worn.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the exemplary latching structure and portable electronic device with the same. Moreover, in the drawings like reference numerals designate corresponding parts throughout the several views. Wherever possible, the same reference numbers are used throughout the drawings to refer to the same or like elements of an embodiment.

FIG. 1 is an assembled, isometric view of an exemplary embodiment of a portable electronic device, showing the cover half-open.

FIG. 2 is an exploded, isometric view of the portable electronic device shown in FIG. 1, but without a cover.

FIG. 3 is similar to FIG. 2, but viewed from another aspect.

FIG. 4 is a top plan view of the portable electronic device, without the cover and the touch pen.

FIG. 5 is similar to FIG. 4, but with the touch pen.

FIG. 6 is an assembled, isometric view of the portable electronic device, but not showing the touch pen.

FIG. 7 is an assembled, isometric view of the portable electronic device shown in FIG. 1.

### DETAILED DESCRIPTION

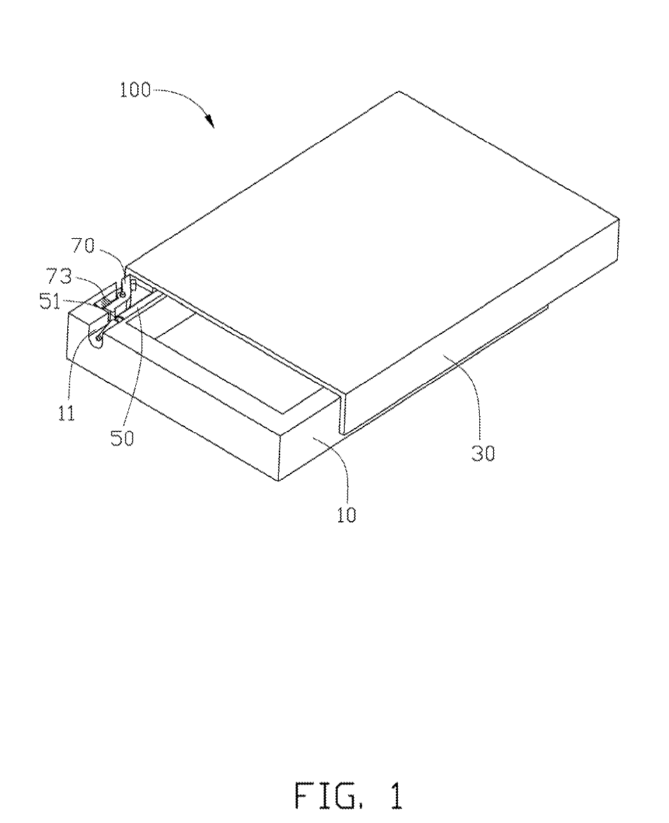

Referring to FIG. 1, an exemplary embodiment of a portable electronic device 100, such as mobile phone, PDA and so on, includes a housing 10, a cover 30, a touch pen 50, and a latching module 70. The cover 30 is slidably mounted on the housing 10. The touch pen 50 defines a groove 51. The touch pen 50 is detachably fixed in the housing 10. The latching module 70 elastically resists against the groove 51 to retain the touch pen 50.

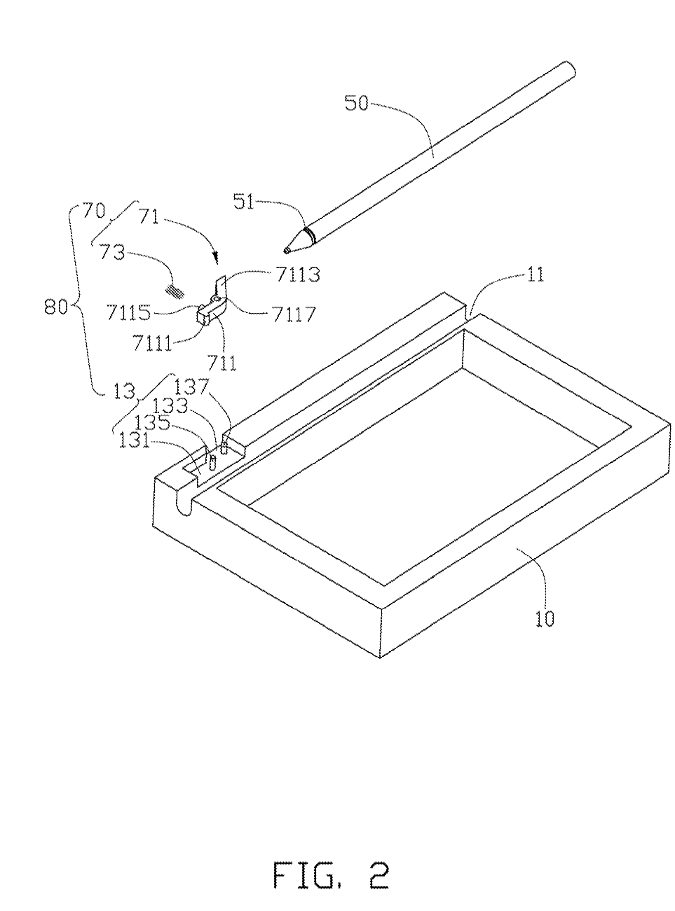

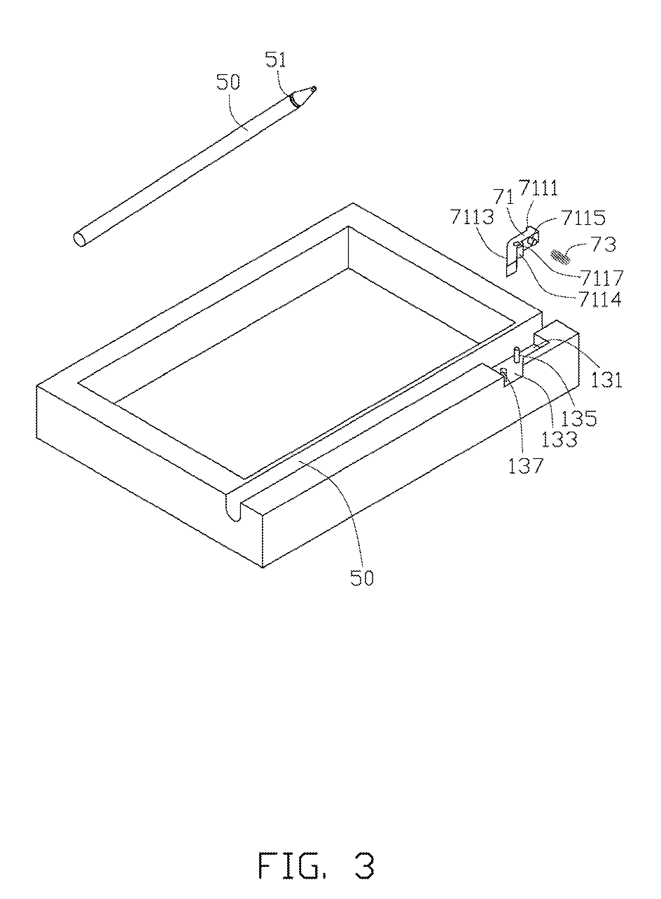

Referring to FIGS. 2 and 3, the housing 10 defines a slot 11 to receive the touch pen 50 and has a mounting portion 13 to mount the latching module 70. The mounting portion 13 and the latching module 70 form a latching structure 80 to latch the touch pen 50. The housing 10 defines a chamber 13 and a notch 133 communicating with the chamber 13. A positioning post 135 and a resisting block 137 extend upward from the bottom wall of the chamber 13, and the resisting block 137 is next to the notch 133. The chamber 131, parallel to the slot 11, communicates with the notch 133. The size of the end of the notch 133 that communicates with the chamber 131 is larger than that of the other end. The notch 133 runs through the wall of the housing 10.

The latching module 70 includes a latching element 71 and an elastic element 73. The latching element 71 includes a base 711. A protrusion 7111 is projected from an end of the base 71 to resist against the groove 51 of the touch pen 50. The base 711 has an operating portion 7113 opposite to the protrusion 7111. The operating portion 7113 forms an angle with the base 711. In this embodiment, the angle is a obtuse angle. A pin 7115 is projected from the base 711 to fix the elastic element 73. The pin 7115 is on a side of the base 711 opposite to the protrusion 7111. The junction of the base 711 and the operating portion 7113 form an arcuate protrusion 7114. The arcuate protrusion 7114 defines a positioning hole 7117 to receive the positioning post 135. By the engagement of the positioning hole 7117 and the positioning post 135, the latching element 71 is rotationally fixed on the housing 10. In this embodiment, the elastic element 73 is a helical spring.

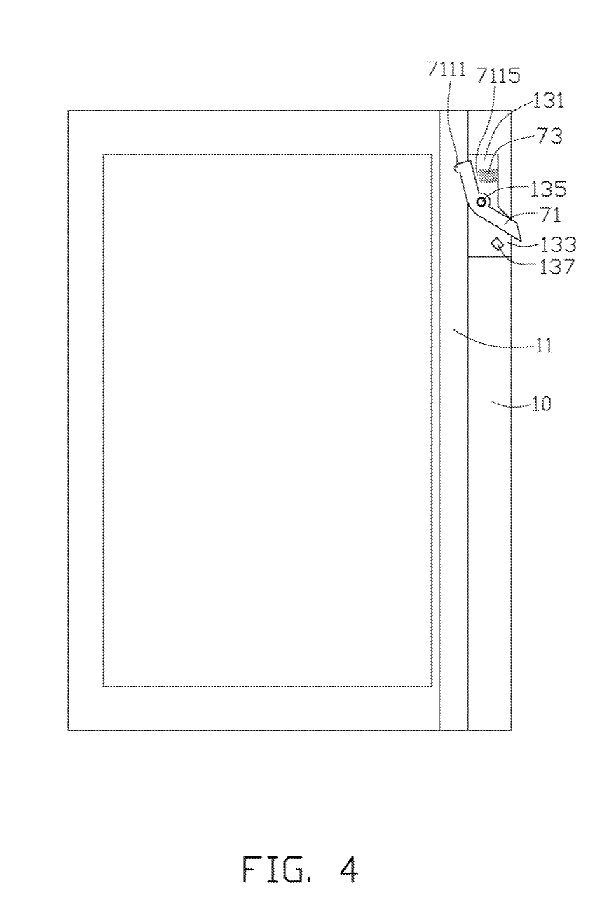

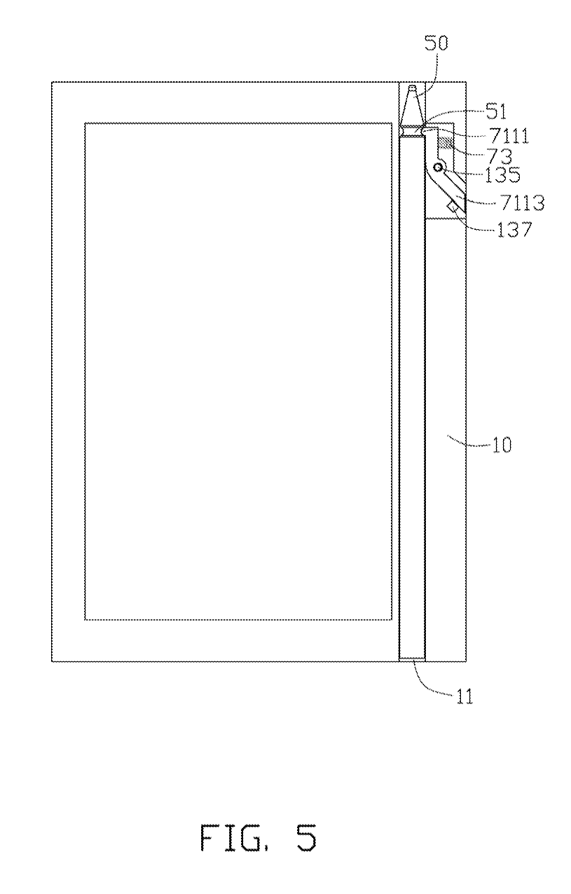

Referring to FIGS. 4 and 5, to assemble the portable electronic device 100, firstly, the elastic element 73 surrounds the pin 7115 of the latching element 71. The positioning post 135 is put into the positioning hole 7117 to rotationally fix the latching element 71 on the housing 10 and extend out of the housing 10. The base 711 is received in the chamber 131. The operating portion 7113 runs through the notch 133 and extends out of the housing 10, at the same time, the protrusion 7111 inserts into the slot 11. Therefore, before assembling the touch pen 50, the cover 30 cannot be mounted on the housing 10 due to latching element 71 extending out of the housing 10, thus preventing a user from forgetting to replace the touch pen 50.

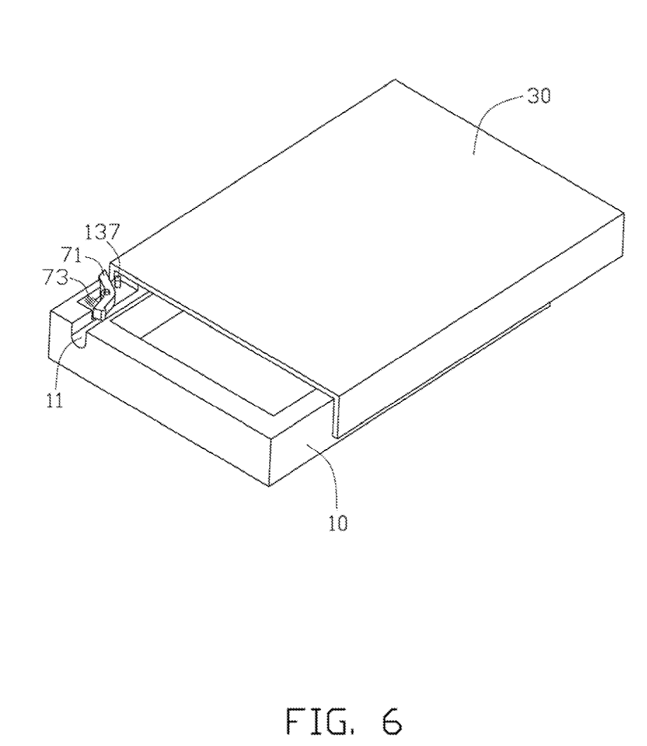

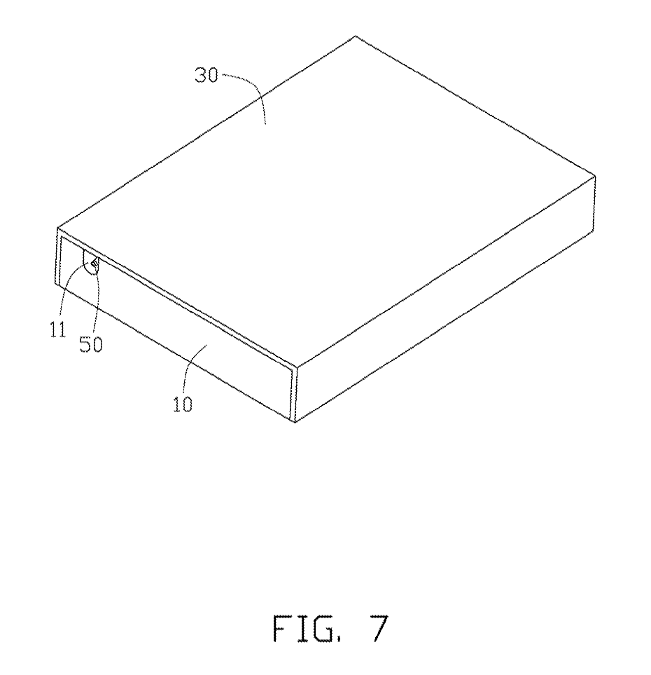

Referring to FIGS. 6 and 7, then the touch pen 50 is inserted into the slot 11. The elastic element 73 is compressed. Under force of the elastic element 73, the protrusion 7111 is received in the groove 51 and resists against the touch pen 50 to prevent the touch pen 50 moving in the slot 11. At the same time, the latching element 71 revolves around the positioning post 135, as a result, the operating portion 7113 revolves towards the slot 11 and finally resists against the resisting block 137 and the operating portion 7113 is parallel to the side wall of the housing 10. Thus, the latching portion 71 no longer extends out of the housing 10.

Finally, the cover 30 is slidably mounted on the housing 10. Thus, the portable electronic device 100 is assembled.

When detaching the touch pen 50 from the portable electronic device 100, the touch pen 50 is manually drawn to make the protrusion 7111 of the latching module 70 to slip from the groove 51, until the touch pen 50 is detached from the portable electronic device 100. The end of the operating portion 7113 resists against the cover 30, so that the latching element 71 does not revolve around the positioning post 135 which makes it easy to insert the touch pen 50 later.

It is to be understood, the resisting block 137 can be omitted, thus, the end of the operating portion 7113 directly resists against the housing 10. Additionally, the transverse section of the notch 133 is not limited to trapezoidal, it can be other shapes, such as rectangular, at the same time, the inclination between the operating portion 7113 and the base 711 should be changed correspondingly. Further, in the housing 10, the number of mounting portions 13 is not limited, and accordingly, the touch pen 50 can define a corresponding number of grooves 51 and the portable electronic device 100 may have more than one latching module 70 to latch the touch pen 50 in the housing 10.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A latching structure for a portable electronic device, the portable electronic device having a touch pen and a housing defining a slot to receive the touch pen, the latching structure comprising:
a mounting portion formed on the housing; and
a latching module fixed in the mounting portion, the latching module having a latching element and an elastic element;
wherein the latching element is rotationally mounted in the mounting portion to elastically resist against the touch pen under the elastic force of the elastic element.

2. The latching structure of claim 1, wherein the mounting portion includes a chamber defined in the housing and a notch communicates with the chamber, the latching element includes a base received in the chamber.

3. The latching structure of claim 2, wherein the base includes an operating portion on one end of the base, the operating portion is rotationally fixed in the notch and extends out of the housing when the touch pen is removed from the housing.

4. The latching structure of claim 3, wherein the base includes a protrusion on the opposite end of the operating portion, the touch pen defines a groove to receive the protrusion.

5. The latching structure of claim 2, wherein the mounting portion includes a positioning post, the base defines a positioning hole therein to receive the positioning post.

6. A portable electronic device, comprising:
a touch pen;
a housing defined a slot therein to receive the touch pen;
a mounting portion formed on the housing; and
a latching structure fixed in the mounting portion;
wherein the latching structure has a latching element and an elastic element; the latching element is rotationally fixed in the mounting portion and elastically resists against the touch pen under the elastic force of the elastic element.

7. The portable electronic device of claim 6, wherein the housing defines a chamber and a notch communicated with the chamber, the latching element includes a base, the base is received in the chamber and the notch.

8. The portable electronic device of claim 7, wherein the base includes an operating portion formed on one end of the base, the operating portion is rotationally fixed in the notch and extends out of the housing when the touch pen is removed from the housing.

9. The portable electronic device of claim 8, wherein the base includes a protrusion on the opposite end of the operating portion thereon, the touch pen defines a groove to receive the protrusion.

10. The portable electronic device of claim 9, wherein the operating portion forms a obtuse angle with the base.

11. The portable electronic device of claim 6, wherein the mounting portion includes a positioning post, the base defined a positioning hole thereon to receive the positioning post.

12. The portable electronic device of claim 6, wherein the portable electronic device further includes a cover, the cover is slidably fixed on the housing.
